(19) United States
(12) Patent Application Publication
(10) Pub. No.: US 2025/0382716 A1
(43) Pub. Date: Dec. 18, 2025

(54) MEMBRANE SEPARATORS

(71) Applicant: UOP LLC, Des Plaines, IL (US)

(72) Inventors: Chunqing Liu, Arlington Heights, IL (US); Xueliang Dong, Schaumburg, IL (US); Carl Elliot Altman, Pitman, PA (US); Adam Reimnitz, Pine Grove, PA (US); Awdhoot V. Kerkar, Rockaway, NJ (US); Gary M. Skwarek, Kenilworth, NJ (US)

(21) Appl. No.: 19/057,380

(22) Filed: Feb. 19, 2025

Related U.S. Application Data
(60) Provisional application No. 63/659,460, filed on Jun. 13, 2024.

(51) Int. Cl. C25B 13/08; C08J 9/28; C25B 13/02; C25B 13/05

(52) U.S. Cl. CPC C25B 13/08; C08J 9/28; C25B 13/02; C25B 13/05

(57) ABSTRACT

Methods of making porous flat sheet membranes and membranes made by the methods are described. The methods comprise mixing and melting a first polymer and a second polymer to form a polymer mixture which is then formed into a film layer. The second polymer is removed from the film layer to form the porous flat sheet membrane. The film layer can be formed by melt extrusion or calendering. A continuous non-porous coating layer can be deposited on the porous flat sheet membrane to form a composite flat sheet membrane. The pores of the porous flat sheet membrane can be impregnated with a third polymer to form an impregnated flat sheet membrane. A continuous non-porous coating layer can be deposited on the impregnated flat sheet membrane to form a composite impregnated flat sheet membrane.

### RELATED APPLICATIONS

This application claims priority to U.S. Provisional Patent Application Ser. No. 63/659,460, filed on Jun. 13, 2024, the entirety of which is incorporated herein by reference.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline water electrolysis (AEL), proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

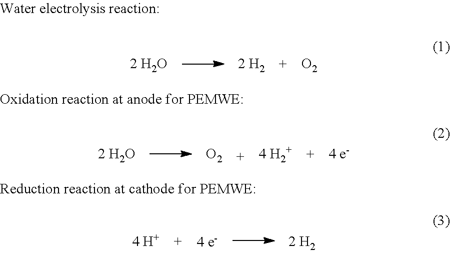

AEMWE has an advantage over PEMWE because it permits the use of less expensive platinum metal-free catalysts, such as Ni and Ni alloy catalysts. In addition, much cheaper stainless steel bipolar plates can be used in the gas diffusion layers (GDL) for AEMWE, instead of the expensive Pt-coated Ti bipolar plates currently used in PEMWE. However, the largest impediments to the development of AEM systems are membrane hydroxyl ion conductivity and stability, as well as lack of understanding of how to integrate catalysts into AEM systems. Research on AEMWE in the literature has been focused on developing electrocatalysts, AEMs, and understanding the operational mechanisms with the general objective of obtaining a high efficiency, low cost and stable AEMWE technology.

AEL will likely remain the dominant electrolysis technology in the long-term, especially for large scale hydrogen production (gigawatt scale) as a result of using lower cost materials, such as steel and nickel, rather than expensive platinum and iridium.

In recent years, development of AEL technology has intensified to further optimize the components, improve the efficiency, and reduce the cost of the AEL system. In addition to new electrocatalysts, the focus has become the development and optimization of other cell components, especially the separators. The separator is a porous barrier placed between the electrodes to prevent the direct mixing of the product gases inside the electrolysis cell. Asbestos was used first as a diaphragm in the water electrolysis cell until this material was banned due to health concerns. Polysulfone (PSU) and polyphenylene sulfide (PPS) have been selected as promising new materials to replace asbestos. However, these polymers are slightly hydrophobic, and the wettability by the electrolyte solution (25-30 wt % KOH) is low, resulting in high ionic resistance. Therefore, hydrophilic materials like inorganic particles or other polymers have been added to improve the overall wettability. The composite materials showed improved chemical and mechanical stability and electrolyte wettability. A typical example is Zirfon™ porous composite separator composed of a polysulfone matrix and zirconium dioxide (ZrO₂). Currently, Zirfon™ separator membranes manufactured by Agfa are the most well-known separators used for AEL.

For this type of composite separator membrane, the overall performance is strongly dependent on the detailed microstructure and chemical composition. Zrifon™ separator membranes have a symmetric structure which increases the ionic transport resistance.

Highly efficient and low-cost water electrolysis is needed for the development of a future hydrogen economy based on renewable energy. The elimination or mitigation of the indirect energy losses arising from gas crossover in the electrolyzers would provide significant energy savings for water electrolysis. Gas permeation through the water electrolyzer will lead to H₂ in O₂ at the anode side of the electrolyzer, which causes a safety hazard and the reduction of the electrolyzer efficiency. Innovations to improve the efficiency and reduce the cost of water electrolyzers, such as the design of the catalyst-coated membranes (CCMs) with low H₂ crossover for proton exchange membrane (PEM) water electrolysis and anion exchange membrane (AEM) water electrolysis and/or the design of very small pore membrane separators for alkaline water electrolysis are desired.

Non-fluorinated polymers and membranes are less expensive than fluorinated (PFSA) polymers and have much lower environmental impact. They can be made from aliphatic or aromatic polymers with benzene ring structures in the backbone or in the pendant groups attached to the membrane polymeric backbone. Design and development of novel non-PFSA membranes for water, CO₂ and other electrolysis, fuel cell, batteries, and other electrochemical applications is desired.

Therefore, the development of new separation membranes is desired.

### BRIEF DESCRIPTION OF THE DRAWINGS

FIG. 1 is an illustration of one embodiment of a PEMWE cell.

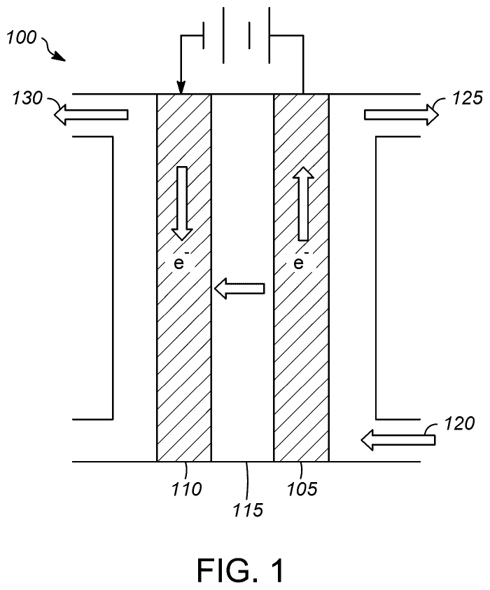

FIG. 2 is an illustration of one embodiment of a method of making the porous flat sheet or composite flat sheet membrane of the present invention.

FIG. 3 is an illustration of one embodiment of a method of making the impregnated flat sheet membrane or the composite impregnated flat sheet membrane of the present invention.

### DESCRIPTION OF THE INVENTION

This present invention relates to new types of low-cost stable porous flat sheet membranes and methods of making these membranes. The membrane can be used in a wide variety of applications including, but not limited to, alkaline water electrolysis, gas, liquid and vapor separations (such as CO₂/H₂S/CH₄, H₂/CH₄, O₂/N₂, and CO₂/N₂ separations), green H₂, fuel cells, flow batteries, Li or Na ion batteries, solid-state batteries, Li metal recovery, catalyst recovery, and the like.

The porous flat sheet membrane may have a continuous non-porous polymer coating layer on one surface or both surfaces of a low-cost stable porous flat sheet membrane. In some cases, the pores of the porous flat sheet membrane are impregnated with a high performance polymer. There can be a continuous non-porous polymer coating layer on one surface or both surfaces of the impregnated flat sheet membrane. In addition, there can be a porous coating layer between the porous flat sheet membrane and the continuous non-porous polymer coating layer or between the impregnated flat sheet membrane and the continuous non-porous polymer coating layer.

One aspect of the invention is a method of making a porous flat sheet membrane. In one embodiment, the method comprises mixing and melting a first polymer and a second polymer with a weight ratio in a range of 20:1 to 1:5, or 10:1 to 1:2, or 2:1 to 1:2, to form a polymer mixture which is then formed into a film layer.

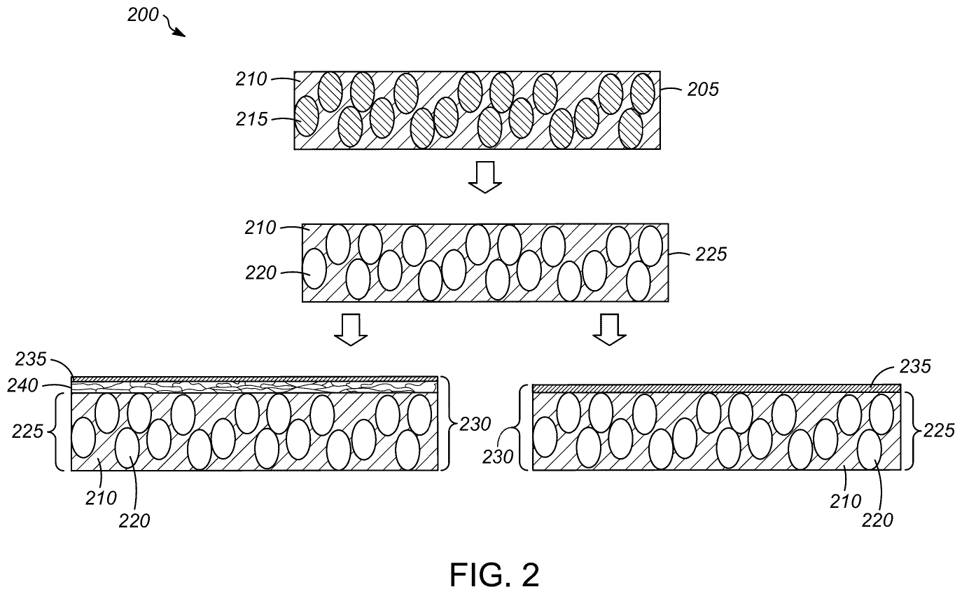

As illustrated in FIG. 2, the method 200, the film layer 205 comprises a mixture of the first polymer 210 and the second polymer 215.

The first polymer 210 is insoluble in a solvent or does not decompose in the presence of a decomposing agent, and the second polymer 215 is soluble in the solvent, or decomposes in the presence of the decomposing agent.

The solvent comprises water, an organic solvent, or a mixture thereof. Any suitable organic solvent can be used. Suitable organic solvents, include, but are not limited to, an alcohol, 1,3-dioxolane, tetrahydrofuran, 2-methyltetrahydrofuran, acetone, N-methyl-2-pyrrolidone (NMP), dimethylacetamide (DMAc), dimethylformamide (DMF), dimethyl sulfoxide (DMSO), 1,4-dioxane, chloroform, acetonitrile, acetic acid, ethyl acetate, dichloromethane, isoamyl acetate, isoamyl methyl carbonate, 2,2-dimethyl-1,3-dioxolane-4-methanol, glycerol, ethylene glycol, propylene glycol, or combinations thereof.

Any suitable decomposing agent can be used. Suitable decomposing agents include, but are not limited to, primary aliphatic amines, secondary aliphatic amines, tertiary aliphatic amines, ammonia, tetraalkylammonium hydroxide, metal hydroxide, or combinations thereof.

Any suitable polymer which is insoluble in the solvent or does not decompose in the presence of a decomposing agent can be used as the first polymer 210. Suitable first polymers 210 include, but are not limited to, polyphenylene sulfide (PPS), poly(ether ether ketone) (PEEK), polytetrafluoroethylene, polyethylene, polypropylene, copolymers of tetrafluoroethylene and ethylene, copolymers of tetrafluoroethylene and propylene, copolymers of ethylene and propylene, polychlorotrifluoroethylene, copolymers of chlorotrifluoroethylene and vinylidene fluoride, copolymers of chlorotrifluoroethylene and ethylene, or combinations thereof.

Any suitable polymer which is soluble in the solvent or decomposes in the presence of the decomposing agent can be used as the second polymer 215. Suitable second polymers 215 include, but are not limited to, polyetherimides, polyethersulfone, polyimides, polysulfones, sulfonated polysulfones, sulfonated polyethersulfones, sulfonated poly(ether ether ketone), cellulose acetate, cellulose triacetate, polyacrylonitrile, polyamines, polyvinyl alcohol, or combinations thereof.

The film layer 205 can be formed by melt extrusion or calendering. The thickness of the film layer 205 can be in the range of 5 to 500 μm, or 5 to 400 μm, or 5 to 300 μm, or 5 to 200 μm, or 5 to 150 μm, or 10 to 500 μm, or 10 to 400 μm, or 10 to 300 μm, or 10 to 200 μm, or 10 to 150 μm, or 50 to 500 μm, or 50 to 400 μm, or 50 to 300 μm, or 50 to 200 μm, or 50 to 150 μm, or 100 to 500 μm, or 100 to 400 μm, or 100 to 300 μm, or 100 to 200 μm, or 100 to 150 μm.

The mixing and melting of the polymers and forming the film layer can be performed in one or more extruder(s). For example, the polymers can be mixed, melted, and the film layer 205 can be formed in a single extruder. In other cases, the polymers are not sufficiently mixed in a single extruder, and a second (or later) extruder is used for additional mixing, and the film layer 205 is formed in the second (or later) extruder. The extrusion conditions will depend on the specific polymers being used. The conditions can be determined by those skilled in the art. For example, the extrusion temperature can be in a range of 200 to 500° C., or in a range of 250 to 400° C., or in a range of 270 to 400° C., or in a range of 300 to 400° C.

The melt extrusion process may include multiple compaction steps and conversion of the polymers in powder, pellet, or any other form into a film or flat sheet product of uniform thickness using an extruder. The extruder may include a hopper, a single screw or twin screw, a heater, a barrel, a filter screen, an adapter, a slot die, and an extrusion line with rollers. The extruder may include a feed section, a compression or compaction section, a metering section, a coating or casting section, and optionally an annealing section.

In some cases, the melt extrusion process can be done in one extruder including the steps of: 1) melting and mixing the first polymer, second polymer, and any other additives in the feed section of an extruder equipped with a feed hopper at an elevated temperature in a range of 200 to 500° C., or in a range of 250 to 400° C., or in a range of 270 to 400° C., or in a range of 300 to 400° C. to form an extrudable viscous molten mixture with uniformly mixed first polymer and second polymer; 2) extruding the molten mixture through the compression or compaction section, the metering section, the coating or casting section, and optionally the annealing section of the extruder to form a film layer with a uniform width, thickness and surface; 3) winding the film on a winder. During the melt extrusion process, the process parameters such as the extrusion temperature, pressure, feeding rate, and screw speed can be adjusted for specific polymers being extruded.

In some cases, the melt extrusion process can be done in two or more extruders including the steps of: 1) mixing the first polymer, second polymer, and any other additives in a first extruder at an elevated temperature in a range of 200 to 500° C., or in a range of 250 to 400° C., or in a range of 270 to 400° C., or in a range of 300 to 400° C. to form an extruded mixture with uniformly mixed first polymer and second polymer and in the form of pellets, beads, or other suitable shapes; 2) introducing the extruded mixture to a feed hopper of a second extruder to melt and further mix the mixture; 3) extruding the mixture through the compression or compaction section, the metering section, the coating or casting section equipped with a temperature controlled coating or casting rolls, and optionally the annealing section of the extruder to form a film layer with a uniform width, thickness and surface; 4) winding the film on a winder.

The quality of the extruded film may be controlled by barrel temperature, slot die temperature, roller temperature, screw speed, screw tightness, and line speed.

A calendering process includes the steps of: 1) melting and mixing a first polymer, a second polymer, and any other additives in the barrel of an extruder at an elevated temperature in a range of 200 to 500° C., or in a range of 250 to 400° C., or in a range of 270 to 400° C., or in a range of 300 to 400° C. to form an extrudable viscous molten mixture with uniformly mixed first polymer and second polymer; 2) extruding the molten mixture onto one of a series of highly polished temperature controller metallic rolls in a roll stack, wherein the rolls have a gap between them that determines the thickness of the film. The molten polymer mixture gradually cools when it passes between the rolls. The pressure of the rolls spreads the molten polymer mixture evenly to form a continuous length of high-quality film layer with a uniform width, thickness and surface.

The second polymer 215 is removed from the film layer 205 resulting in pores 220 in the film layer 205 where the second polymer 215 had been and forming the porous flat sheet membrane 225. The second polymer 215 can be removed by any suitable process. Suitable processes include, but are not limited to, dissolving the second polymer with the solvent or decomposing the second polymer with the decomposing agent.

In some embodiments, a composite flat sheet membrane 230 can be formed by depositing a continuous non-porous coating layer 235 on the first surface or the second surface or both of the porous flat sheet membrane 225. The continuous non-porous coating layer 235 may have a thickness of 10 μm or less, or 5 μm or less, or 1 μm or less, or 750 nm or less, or 500 nm or less, or 250 nm or less, or 125 nm or less, or 100 nm or less, or 90 nm or less, or 80 nm or less, or 75 nm or less, or 70 nm or less, or 60 nm or less, or 50 nm or less, or 40 nm or less, or 30 nm or less, or 25 nm or less, or 20 nm or less, or in the range of 10-20 nm.

The continuous non-porous coating layer 235 may comprise any suitable polymers. Suitable polymers for the continuous non-porous coating layers 235 include, but are not limited to, polyimides, polyetherimides, polyethersulfones, blends of polyimides and polyethersulfones, polysulfones, blends of polyimides and polysulfones, cellulose acetate, cellulose triacetate, polybenzimidazole, polyacrylonitrile, polymers with intrinsic microporosity (PIM), polyether block amide copolymers, polyethers, poly(1,3-dioxolane), polyamines, cross-linked polyamines, polysaccharide polymers, fluorinated proton exchange polymers, non-fluorinated proton exchange polymers, non-fluorinated anion exchange polymers, or combinations thereof.

The continuous non-porous coating layer 235 can be deposited by any suitable process. Suitable processes include, but are not limited to, meniscus coating, dip coating, casting, slot-die coating, gravure coating, spray coating, laminating, atomic layer deposition, magnetron sputter deposition, or combinations thereof.

In some embodiments, a porous coating layer 240 with a thickness of 50 nm to 200 μm, or 50 nm to 100 μm, or 50 nm to 50 μm, 500 nm to 200 μm, or 500 nm to 100 μm, or 500 nm to 50 μm, 750 nm to 200 μm, or 750 nm to 100 μm, or 750 nm to 50 μm, or 1 μm to 200 μm, or 1 μm to 100 μm, or 1 μm to 50 μm, or 1 μm to 40 μm, or 1 μm to 30 μm, or 1 μm to 20 μm, or 1 μm to 10 μm, is deposited on the first surface or the second surface or both of the porous flat sheet membrane 225 before depositing the continuous non-porous coating layer 235. The porous coating layer 240 may comprise any suitable polymers. Suitable polymers for the porous coating layer 240 include, but are not limited to, polymers with intrinsic microporosity (PIM), polyether block amide copolymers, polyethers, poly(1,3-dioxolane), polyamines, cross-linked polyamines, polysaccharide polymers, cross-linked polyorganosilanes, Teflon® amorphous fluoropolymers, or combinations thereof. The polymer for the porous coating layer 240 is different from the polymer for the continuous non-porous coating layer 235 on top of it.

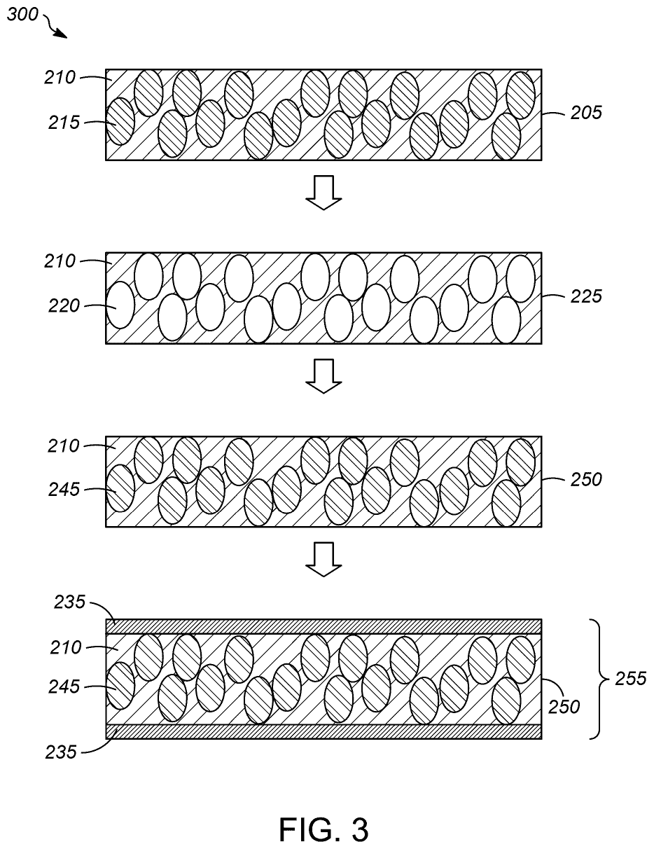

In the method 300 shown in FIG. 3, the pores 220 of the porous flat sheet membrane 225 are impregnated with a third polymer 245 to form an impregnated flat sheet membrane 250. The third polymer 245 should have high chemical and thermal stability, and high ionic conductivity, and good solubility or dispersion property in solvents, such as organic solvents. Any suitable third polymer 245 can be used. Suitable third polymers 245 include, but are not limited to, polysaccharide polymers, such as Na-alginate or chitosan, fluorinated proton exchange polymers, such as a copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro (2,2-dimethyl-1,3-dioxole), a copolymer of perfluoro-5-oxa-6-heptene-sulfonic acid and perfluoro (2,2-dimethyl-1,3-dioxole), a copolymer of perfluoro-4-oxa-5-hexene-sulfonic acid and perfluoro (2,2-dimethyl-1,3-dioxole), a copolymer of perfluoro-3-oxa-4-pentene-sulfonic acid and perfluoro (2,2-dimethyl-1,3-dioxole), a copolymer of perfluoro-3,6-dioxa-4-methyl-7-octene-sulfonic acid and perfluoro (2-methylene-4-methyl-1,3-dioxolane), a copolymer of perfluoro-5-oxa-6-heptene-sulfonic acid and perfluoro (2-methylene-4-methyl-1,3-dioxolane), a copolymer of perfluoro-4-oxa-5-hexene-sulfonic acid and perfluoro (2-methylene-4-methyl-1,3-dioxolane), a copolymer of perfluoro-3-oxa-4-pentene-sulfonic acid and perfluoro (2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, a copolymer of perfluoro-3-oxa-4-pentene-sulfonic acid and 2,2,4-trifluoro-5-trifluoromethoxy-1,3-dioxole, non-fluorinated proton exchange polymers, such as sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated poly(isatin-4,4′-biphenol-p-terphenyl), sulfonated poly(isatin-2,2′-biphenol-p-terphenyl), poly(isatin-1,1′-bi-2-naphthol-p-terphenyl), sulfonated poly(p-terphenyl-2,2′-biphenol-1-3-isatin-2,2,2-trifluoroacetophenone-4-1), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, cross-linked sulfonated poly(vinyl toluene), or combinations thereof, non-fluorinated anion exchange polymers such as poly(terphenylene-co-phenanthrenylene piperidinium iodide), poly(terphenylene-co-phenanthrenylene piperidinium bicarbonate), poly(terphenylene-co-phenanthrenylene piperidinium acetate)), or combinations thereof.

Any suitable impregnation process can be used. Suitable impregnation processes include, but are not limited to, polymer solution impregnation, meniscus coating, dip coating, casting, slot-die coating, gravure coating, spray coating, laminating, atomic layer deposition, magnetron sputter deposition, or combinations thereof.

In some embodiments, a continuous non-porous coating layer 235 may be deposited on a first surface or a second surface or both of the impregnated flat sheet membrane 250 to form a composite impregnated flat sheet membrane 255. In some embodiments, the continuous non-porous coating layer 235 may have a thickness of 10 μm or less.

The continuous non-porous coating layer 235 may be deposited using any suitable process. Suitable processes include, but are not limited to, meniscus coating, dip coating, casting, slot-die coating, gravure coating, spray coating, laminating, atomic layer deposition, magnetron sputter deposition, or combinations thereof.

The continuous non-porous coating layer 235 can be made from any suitable polymer. Suitable polymers include, but are not limited to, polyimides, polyetherimides, polyethersulfones, blends of polyimides and polyethersulfones, polysulfones, blends of polyimides and polysulfones, cellulose acetate, cellulose triacetate, polybenzimidazole, polyacrylonitrile, polymer with intrinsic microporosity (PIM), polyether block amide copolymers, polyethers, poly(1,3-dioxolane) s, polyamines, cross-linked polyamines, polysaccharide polymers, such as Na-alginate or chitosan, fluorinated proton exchange polymers, non-fluorinated proton exchange polymers, non-fluorinated anion exchange polymers, or combinations thereof.

In some embodiments, a porous coating layer (not shown) is deposited on the first surface or the second surface or both of the impregnated flat sheet membrane 250 before depositing the continuous non-porous coating layer 235.

In some embodiments, the polymer mixture further comprises an inorganic compound. The inorganic compounds are used to create additional pores between the inorganic compounds and the first polymer or to improve the mechanical strength of the porous flat sheet membrane 225, or both. Any suitable inorganic compound can be used. Suitable inorganic compounds include, but are not limited to, zirconium oxide, iron oxide, nickel oxide, cobalt oxide, copper oxide, manganese oxide, molybdenum oxide, titanium oxide, antimony oxide, or combinations thereof.

In some embodiments, the polymer mixture further comprises mineral oil, a phthalate ester, sebacate, adipate, a terephthalate, dibenzoate, glutarate, a plasticizer, or combinations thereof. These additives increase the flow and thermoplasticity of the polymer mixture by decreasing the viscosity, the glass transition temperature, or the melting temperature of the polymer mixture, therefore improving the processability for melt extrusion or calendering.

Another aspect of the invention is an impregnated flat sheet membrane 250. In one embodiment, the impregnated flat sheet membrane 250 comprises an impregnated flat sheet membrane 250 having pores containing the third polymer 245 comprising a polysaccharide polymer, a fluorinated proton exchange polymer, a non-fluorinated proton exchange polymer, a non-fluorinated anion exchange polymer, or combinations thereof; wherein the impregnated flat sheet membrane 250 comprises a first polymer 210 insoluble in a solvent comprising water, an organic solvent, or a mixture thereof, or a first polymer 210 not decomposable in the presence of a decomposing agent comprising a primary aliphatic amine, a secondary aliphatic amine, a tertiary aliphatic amine, ammonia, tetraalkylammonium hydroxide, metal hydroxide, or combinations thereof.

Any suitable polymer which is insoluble in the solvent or does not decompose in the presence of a decomposing agent can be used as the first polymer 210. Suitable first polymers 210 include, but are not limited to, polyphenylene sulfide (PPS), poly(ether ether ketone) (PEEK), polytetrafluoroethylene, polyethylene, polypropylene, copolymers of tetrafluoroethylene and ethylene, copolymers of tetrafluoroethylene and propylene, copolymers of ethylene and propylene, polychlorotrifluoroethylene, copolymers of chlorotrifluoroethylene and vinylidene fluoride, copolymers of chlorotrifluoroethylene and ethylene, or combinations thereof.

In some embodiments, the impregnated flat sheet membrane 250 further comprises an inorganic compound. Any suitable inorganic compound can be used. Suitable inorganic compounds include, but are not limited to, zirconium oxide, iron oxide, nickel oxide, cobalt oxide, copper oxide, manganese oxide, molybdenum oxide, titanium oxide, antimony oxide, or combinations thereof.

In some embodiments, the polymer mixture further comprises mineral oil, a phthalate ester, sebacate, adipate, a terephthalate, dibenzoate, glutarate, a plasticizer, or combinations thereof.

In some embodiments, the impregnated flat sheet membrane 250 further comprises a continuous non-porous coating layer 235 on a first surface or a second surface or both of the impregnated flat sheet membrane 250 to form a composite impregnated flat sheet membrane 255. In some embodiments, the continuous non-porous coating layer 235 has a thickness of 10 μm or less.

The continuous non-porous coating layer 235 may comprise any suitable polymers. Suitable polymers for the continuous non-porous coating layer 235 include, but are limited to, polyimides, polyetherimides, polyethersulfones, blends of polyimides and polyethersulfones, polysulfones, blends of polyimides and polysulfones, cellulose acetate, cellulose triacetate, polybenzimidazole, polyacrylonitrile, polymers with intrinsic microporosity (PIM), polyether block amide copolymers, polyethers, poly(1,3-dioxolane), polyamines, cross-linked polyamines, polysaccharide polymers, fluorinated proton exchange polymer, non-fluorinated proton exchange polymers, non-fluorinated anion exchange polymers, or combinations thereof.

Another aspect of the invention is a porous flat sheet membrane 225. In one embodiment, the porous flat sheet membrane 225 comprises a first polymer 210 insoluble in a solvent or not decomposable in the presence of a decomposing agent having pores 220. The pores 220 are formed when the second polymer 215 is removed from the film layer 205. The composite flat sheet membrane 230 comprises the porous flat sheet membrane 225 with a continuous non-porous coating layer 235 on a first surface or a second surface or both. The continuous non-porous coating layer 235 may have a thickness of 10 μm or less.

### Specific Embodiments

While the following is described in conjunction with specific embodiments, it will be understood that this description is intended to illustrate and not limit the scope of the preceding description and the appended claims.

A first embodiment of the invention is a method of making a porous flat sheet membrane comprising mixing and melting a first polymer and a second polymer to form a polymer mixture, wherein the first polymer is insoluble in a solvent and the second polymer is soluble in the solvent, or wherein the first polymer does not decompose in the presence of a decomposing agent and the second polymer decomposes in the presence of the decomposing agent; forming a film layer from the polymer mixture; removing the second polymer from the film layer forming the porous flat sheet membrane, wherein the solvent comprises water, an organic solvent, or a mixture thereof. An embodiment of the invention is one, any or all of prior embodiments in this paragraph up through the first embodiment in this paragraph wherein removing the second polymer comprises dissolving the second polymer with the solvent or decomposing the second polymer with the decomposing agent. An embodiment of the invention is one, any or all of prior embodiments in this paragraph up through the first embodiment in this paragraph wherein the solvent is the organic solvent comprising an alcohol, 1,3-dioxolane, tetrahydrofuran, 2-methyltetrahydrofuran, acetone, N-methyl-2-pyrrolidone (NMP), dimethylacetamide (DMAc), dimethylformamide (DMF), dimethyl sulfoxide (DMSO), 1,4-dioxane, chloroform, acetonitrile, acetic acid, ethyl acetate, dichloromethane, isoamyl acetate, isoamyl methyl carbonate, 2,2-dimethyl-1,3-dioxolane-4-methanol, glycerol, ethylene glycol, propylene glycol, or combinations thereof. An embodiment of the invention is one, any or all of prior embodiments in this paragraph up through the first embodiment in this paragraph wherein the decomposing agent comprises a primary aliphatic amine, a secondary aliphatic amine, a tertiary aliphatic amine, ammonia, tetraalkylammonium hydroxide, metal hydroxide, or combinations thereof. An embodiment of the invention is one, any or all of prior embodiments in this paragraph up through the first embodiment in this paragraph further comprising depositing a continuous non-porous coating layer on a first surface or a second surface or both of the porous flat sheet membrane to form a composite flat sheet membrane. An embodiment of the invention is one, any or all of prior embodiments in this paragraph up through the first embodiment in this paragraph wherein the continuous non-porous coating layer comprises a polyimide, a polyetherimide, polyethersulfone, a blend of a polyimide and polyethersulfone, polysulfone, a blend of a polyimide and polysulfone, cellulose acetate, cellulose triacetate, polybenzimidazole, polyacrylonitrile, a polymer with intrinsic microporosity (PIM), a polyether block amide copolymer, a polyether, a poly(1,3-dioxolane), a polyamine, a cross-linked polyamine, a polysaccharide polymer, a fluorinated proton exchange polymer, a non-fluorinated proton exchange polymer, a non-fluorinated anion exchange polymer, or combinations thereof. An embodiment of the invention is one, any or all of prior embodiments in this paragraph up through the first embodiment in this paragraph wherein the continuous non-porous coating layer is deposited by meniscus coating, dip coating, casting, slot-die coating, gravure coating, spray coating, laminating, atomic layer deposition, magnetron sputter deposition, or combinations thereof. An embodiment of the invention is one, any or all of prior embodiments in this paragraph up through the first embodiment in this paragraph wherein the continuous non-porous coating layer has a thickness of 10 μm or less. An embodiment of the invention is one, any or all of prior embodiments in this paragraph up through the first embodiment in this paragraph further comprising depositing porous coating layer on the first surface or the second surface or both of the porous flat sheet membrane before depositing the continuous non-porous coating layer. An embodiment of the invention is one, any or all of prior embodiments in this paragraph up through the first embodiment in this paragraph further comprising impregnating the pores of the porous flat sheet membrane with a third polymer to form an impregnated flat sheet membrane. An embodiment of the invention is one, any or all of prior embodiments in this paragraph up through the first embodiment in this paragraph wherein the pores of the porous flat sheet membrane are impregnated by polymer solution impregnation, meniscus coating, dip coating, casting, slot-die coating, gravure coating, spray coating, laminating, atomic layer deposition, magnetron sputter deposition, or combinations thereof. An embodiment of the invention is one, any or all of prior embodiments in this paragraph up through the first embodiment in this paragraph further comprising depositing continuous non-porous coating layer having a thickness of 10 μm or less on a first surface or a second surface or both of the impregnated composite membrane to form a composite impregnated flat sheet membrane. An embodiment of the invention is one, any or all of prior embodiments in this paragraph up through the first embodiment in this paragraph wherein the continuous non-porous coating layer is deposited by meniscus coating, dip coating, casting, slot-die coating, gravure coating, spray coating, laminating, atomic layer deposition, magnetron sputter deposition, or combinations thereof. An embodiment of the invention is one, any or all of prior embodiments in this paragraph up through the first embodiment in this paragraph wherein the continuous non-porous coating layer comprises a polyimide, a polyetherimide, polyethersulfone, a blend of a polyimide and polyethersulfone, polysulfone, a blend of a polyimide and polysulfone, cellulose acetate, cellulose triacetate, polybenzimidazole, polyacrylonitrile, a polymer with intrinsic microporosity (PIM), a polyether block amide copolymer, a polyether, a poly(1,3-dioxolane), a polyamine, a cross-linked polyamine, a polysaccharide polymer, a fluorinated proton exchange polymer, a non-fluorinated proton exchange polymer, a non-fluorinated anion exchange polymer, or combinations thereof. An embodiment of the invention is one, any or all of prior embodiments in this paragraph up through the first embodiment in this paragraph further comprising depositing a porous coating layer on the first surface or the second surface or both of the impregnated flat sheet membrane before depositing the continuous non-porous coating layer. An embodiment of the invention is one, any or all of prior embodiments in this paragraph up through the first embodiment in this paragraph wherein the third polymer comprises a polysaccharide polymer, a fluorinated proton exchange polymer, a non-fluorinated proton exchange polymer, a non-fluorinated anion exchange polymer, or combinations thereof. An embodiment of the invention is one, any or all of prior embodiments in this paragraph up through the first embodiment in this paragraph wherein the first polymer comprises polyphenylene sulfide (PPS), poly(ether ether ketone) (PEEK), polytetrafluoroethylene, polyethylene, polypropylene, a copolymer of tetrafluoroethylene and ethylene, a copolymer of tetrafluoroethylene and propylene, a copolymer of ethylene and propylene, polychlorotrifluoroethylene, a copolymer of chlorotrifluoroethylene and vinylidene fluoride, a copolymer of chlorotrifluoroethylene and ethylene, or combinations thereof. An embodiment of the invention is one, any or all of prior embodiments in this paragraph up through the first embodiment in this paragraph wherein the second polymer comprises polyetherimide, polyethersulfone, polyimide, polysulfone, sulfonated polysulfone, sulfonated polyethersulfone, sulfonated poly(ether ether ketone), cellulose acetate, cellulose triacetate, polyacrylonitrile, polyamine, polyvinyl alcohol, or combinations thereof. An embodiment of the invention is one, any or all of prior embodiments in this paragraph up through the first embodiment in this paragraph wherein the polymer mixture further comprises an inorganic compound. An embodiment of the invention is one, any or all of prior embodiments in this paragraph up through the first embodiment in this paragraph wherein the inorganic compound comprises zirconium oxide, iron oxide, nickel oxide, cobalt oxide, copper oxide, manganese oxide, molybdenum oxide, titanium oxide, antimony oxide, or combinations thereof. An embodiment of the invention is one, any or all of prior embodiments in this paragraph up through the first embodiment in this paragraph wherein the polymer mixture further comprises mineral oil, a phthalate ester, sebacate, adipate, a terephthalate, dibenzoate, glutarate, a plasticizer, or combinations thereof. An embodiment of the invention is one, any or all of prior embodiments in this paragraph up through the first embodiment in this paragraph wherein the film layer is formed by melt extrusion or calendering.

A second embodiment of the invention is an impregnated flat sheet membrane comprising an impregnated flat sheet membrane having pores containing a polysaccharide polymer, a fluorinated proton exchange polymer, a non-fluorinated proton exchange polymer, a non-fluorinated anion exchange polymer, or combinations thereof; wherein the flat sheet membrane comprises a first polymer insoluble in a solvent comprising water, an organic solvent, or a mixture thereof, or a first polymer not decomposable in the presence of a decomposing agent comprising a primary aliphatic amine, a secondary aliphatic amine, a tertiary aliphatic amine, ammonia, tetraalkylammonium hydroxide, metal hydroxide, or combinations thereof. An embodiment of the invention is one, any or all of prior embodiments in this paragraph up through the second embodiment in this paragraph wherein the first polymer comprises polyphenylene sulfide (PPS), poly(ether ether ketone) (PEEK), polytetrafluoroethylene, polyethylene, polypropylene, a copolymer of tetrafluoroethylene and ethylene, a copolymer of tetrafluoroethylene and propylene, a copolymer of ethylene and propylene, polychlorotrifluoroethylene, a copolymer of chlorotrifluoroethylene and vinylidene fluoride, a copolymer of chlorotrifluoroethylene and ethylene, or combinations thereof, An embodiment of the invention is one, any or all of prior embodiments in this paragraph up through the second embodiment in this paragraph further comprising an inorganic compound. An embodiment of the invention is one, any or all of prior embodiments in this paragraph up through the second embodiment in this paragraph wherein the inorganic compound comprises zirconium oxide, iron oxide, nickel oxide, cobalt oxide, copper oxide, manganese oxide, molybdenum oxide, titanium oxide, antimony oxide, or combinations thereof. An embodiment of the invention is one, any or all of prior embodiments in this paragraph up through the second embodiment in this paragraph further comprising a continuous non-porous coating layer on a first surface or a second surface or both of the impregnated flat sheet membrane to form a composite impregnated flat sheet membrane. An embodiment of the invention is one, any or all of prior embodiments in this paragraph up through the second embodiment in this paragraph wherein the continuous non-porous coating layer comprises a polyimide, a polyetherimide, polyethersulfone, a blend of a polyimide and polyethersulfone, polysulfone, a blend of a polyimide and polysulfone, cellulose acetate, cellulose triacetate, polybenzimidazole, polyacrylonitrile, a polymer with intrinsic microporosity (PIM), a polyether block amide copolymer, a polyether, a poly(1,3-dioxolane), a polyamine, a cross-linked polyamine, a polysaccharide polymer, a fluorinated proton exchange polymer, a non-fluorinated proton exchange polymer, a non-fluorinated anion exchange polymer, or combinations thereof. An embodiment of the invention is one, any or all of prior embodiments in this paragraph up through the second embodiment in this paragraph wherein the continuous non-porous coating layer has a thickness of 10 μm or less.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of making a porous flat sheet membrane comprising:
mixing and melting a first polymer and a second polymer to form a polymer mixture, wherein the first polymer is insoluble in a solvent and the second polymer is soluble in the solvent, or wherein the first polymer does not decompose in the presence of a decomposing agent and the second polymer decomposes in the presence of the decomposing agent;
forming a film layer from the polymer mixture; and
removing the second polymer from the film layer forming the porous flat sheet membrane,
wherein the solvent comprises water, an organic solvent, or a mixture thereof.

2. The method of claim 1 wherein removing the second polymer comprises dissolving the second polymer with the solvent or decomposing the second polymer with the decomposing agent.

3. The method of claim 1 wherein the solvent is the organic solvent comprising an alcohol, 1,3-dioxolane, tetrahydrofuran, 2-methyltetrahydrofuran, acetone, N-methyl-2-pyrrolidone (NMP), dimethylacetamide (DMAc), dimethylformamide (DMF), dimethyl sulfoxide (DMSO), 1,4-dioxane, chloroform, acetonitrile, acetic acid, ethyl acetate, dichloromethane, isoamyl acetate, isoamyl methyl carbonate, 2,2-dimethyl-1,3-dioxolane-4-methanol, glycerol, ethylene glycol, propylene glycol, or combinations thereof.

4. The method of claim 1 wherein the decomposing agent comprises a primary aliphatic amine, a secondary aliphatic amine, a tertiary aliphatic amine, ammonia, tetraalkylammonium hydroxide, metal hydroxide, or combinations thereof.

5. The method of claim 1 further comprising:
depositing a continuous non-porous coating layer on a first surface or a second surface or both of the porous flat sheet membrane to form a composite flat sheet membrane.

6. The method of claim 5 wherein the continuous non-porous coating layer comprises a polyimide, a polyetherimide, polyethersulfone, a blend of a polyimide and polyethersulfone, polysulfone, a blend of a polyimide and polysulfone, cellulose acetate, cellulose triacetate, polybenzimidazole, polyacrylonitrile, a polymer with intrinsic microporosity (PIM), a polyether block amide copolymer, a polyether, a poly(1,3-dioxolane), a polyamine, a cross-linked polyamine, a polysaccharide polymer, a fluorinated proton exchange polymer, a non-fluorinated proton exchange polymer, a non-fluorinated anion exchange polymer, or combinations thereof.

7. The method of claim 5 wherein the continuous non-porous coating layer has a thickness of 10 μm or less.

8. The method of claim 5 further comprising:
depositing porous coating layer on the first surface or the second surface or both of the porous flat sheet membrane before depositing the continuous non-porous coating layer.

9. The method of claim 1 further comprising:
impregnating the pores of the porous flat sheet membrane with a third polymer to form an impregnated flat sheet membrane.

10. The method of claim 9 further comprising:
depositing continuous non-porous coating layer having a thickness of 10 μm or less on a first surface or a second surface or both of the impregnated composite membrane to form a composite impregnated flat sheet membrane.

11. The method of claim 10 wherein the continuous non-porous coating layer comprises a polyimide, a polyetherimide, polyethersulfone, a blend of a polyimide and polyethersulfone, polysulfone, a blend of a polyimide and polysulfone, cellulose acetate, cellulose triacetate, polybenzimidazole, polyacrylonitrile, a polymer with intrinsic microporosity (PIM), a polyether block amide copolymer, a polyether, a poly(1,3-dioxolane), a polyamine, a cross-linked polyamine, a polysaccharide polymer, a fluorinated proton exchange polymer, a non-fluorinated proton exchange polymer, a non-fluorinated anion exchange polymer, or combinations thereof.

12. The method of claim 10 further comprising:
depositing a porous coating layer on the first surface or the second surface or both of the impregnated flat sheet membrane before depositing the continuous non-porous coating layer.

13. The method of claim 9 wherein the third polymer comprises a polysaccharide polymer, a fluorinated proton exchange polymer, a non-fluorinated proton exchange polymer, a non-fluorinated anion exchange polymer, or combinations thereof.

14. The method of claim 1 wherein the first polymer comprises polyphenylene sulfide (PPS), poly(ether ether ketone) (PEEK), polytetrafluoroethylene, polyethylene, polypropylene, a copolymer of tetrafluoroethylene and ethylene, a copolymer of tetrafluoroethylene and propylene, a copolymer of ethylene and propylene, polychlorotrifluoroethylene, a copolymer of chlorotrifluoroethylene and vinylidene fluoride, a copolymer of chlorotrifluoroethylene and ethylene, or combinations thereof.

15. The method of claim 1 wherein the second polymer comprises polyetherimide, polyethersulfone, polyimide, polysulfone, sulfonated polysulfone, sulfonated polyethersulfone, sulfonated poly(ether ether ketone), cellulose acetate, cellulose triacetate, polyacrylonitrile, polyamine, polyvinyl alcohol, or combinations thereof.

16. The method of claim 1 wherein the polymer mixture further comprises an inorganic compound, mineral oil, a phthalate ester, sebacate, adipate, a terephthalate, dibenzoate, glutarate, a plasticizer, or combinations thereof.

17. An impregnated flat sheet membrane comprising:
an impregnated flat sheet membrane having pores containing a polysaccharide polymer, a fluorinated proton exchange polymer, a non-fluorinated proton exchange polymer, a non-fluorinated anion exchange polymer, or combinations thereof;
wherein the flat sheet membrane comprises a first polymer insoluble in a solvent comprising water, an organic solvent, or a mixture thereof, or a first polymer not decomposable in the presence of a decomposing agent comprising a primary aliphatic amine, a secondary aliphatic amine, a tertiary aliphatic amine, ammonia, tetraalkylammonium hydroxide, metal hydroxide, or combinations thereof.

18. The impregnated flat sheet membrane of claim 17 wherein the first polymer comprises polyphenylene sulfide (PPS), poly(ether ether ketone) (PEEK), polytetrafluoroethylene, polyethylene, polypropylene, a copolymer of tetrafluoroethylene and ethylene, a copolymer of tetrafluoroethylene and propylene, a copolymer of ethylene and propylene, polychlorotrifluoroethylene, a copolymer of chlorotrifluoroethylene and vinylidene fluoride, a copolymer of chlorotrifluoroethylene and ethylene, or combinations thereof.

19. The impregnated flat sheet membrane of claim 17 further comprising an inorganic compound.

20. The impregnated flat sheet membrane of claim 17 further comprising a continuous non-porous coating layer on a first surface or a second surface or both of the impregnated flat sheet membrane to form a composite impregnated flat sheet membrane.
